(19) United States
(12) Patent Application Publication
(10) Pub. No.: US 2026/0064399 A1
(43) Pub. Date: Mar. 5, 2026

(54) SYSTEM AND METHOD TO DYNAMICALLY RECONFIGURE VEHICLE SOFTWARE USING TOUCH FILES

(71) Applicant: FCA US LLC, Auburn Hills, MI (US)

(72) Inventors: Raghuvirsinh Sodha, Auburn Hills, MI (US); Andrew Hoin, Auburn Hills, MI (US); Nicholas Peponis, Auburn Hills, MI (US)

(21) Appl. No.: 18/820,646

(22) Filed: Aug. 30, 2024

(51) Int. Cl. G06F 8/65

(52) U.S. Cl. CPC G06F 8/65

(57) ABSTRACT

A method for dynamically configuring a software platform for a vehicle associated with an original equipment manufacturer (OEM) includes providing an electronic control unit (ECU) of the vehicle, establishing a cloud-based network configured to store a plurality of touch files, each touch file defining a set of vehicle configuration parameters, accessing, by the ECU, the cloud-based network to update and store the plurality of touch files, receiving and storing, by the ECU, a software code, wherein the software code identifies a particular touch file of the plurality of touch files, and executing, by the ECU, the software code using the set of vehicle configuration parameters specified by the particular touch file. Each touch file can be an empty file created using a Linux touch command and having a unique or distinct filename that is specified by the software code.

### FIELD

The present application generally relates to vehicle embedded software and, more particularly, to a system and method to dynamically reconfigure vehicle software using touch files.

### BACKGROUND

Today's vehicles include a plurality of electronic control units (ECUs) that are each configured to execute embedded applications or software to perform its respective functionalities. Conventional vehicle embedded software, however, is static and is therefore difficult to update once deployed. This severely limits the ability of original equipment manufacturers (OEMs) and service providers to rapidly meet emerging customer needs or evolving market trends. The long development and testing cycles typically required for periodic firmware updates lead to delayed feature introductions and lost revenue opportunities. Instead of periodic firmware updates, manual configuration changes could be employed, but this is error prone and does not scale well. Some OEMs have also developed proprietary platforms offering more flexibility, but these are expensive to build and maintain and also suffer from interoperability issues. Accordingly, while such conventional solutions do work for their intended purpose, there exists an opportunity for improvement in the relevant art.

### SUMMARY

According to one example aspect of the invention, a dynamically configurable software platform for a vehicle associated with an original equipment manufacturer (OEM) is presented. In one exemplary implementation, the dynamically configurable software platform comprises an electronic control unit (ECU) of the vehicle and a cloud-based network configured to store a plurality of touch files, each touch file defining a set of vehicle configuration parameters, wherein the ECU is configured to access the cloud-based network to update and store the plurality of touch files, receive and store a software code, wherein the software code identifies a particular touch file of the plurality of touch files, and execute the software code using the set of vehicle configuration parameters specified by the particular touch file.

In some implementations, wherein the plurality of touch files are configured to be updated at the cloud-based system without accessing the ECU. In some implementations, the plurality of touch files are configured to be updated at the cloud-based system without a firmware update of the ECU. In some implementations, the plurality of touch files are configured to be updated at the cloud-based system without a manual configuration change of the ECU by a technician.

In some implementations, the software code does not include a definition library. In some implementations, the definition library is a JavaScript Object Notation (JSON) library. In some implementations, the plurality of touch files are associated with each of a plurality of different ECUs of the vehicle. In some implementations, the plurality of touch files are configured to be updated by a programmer or developer of the software code. In some implementations, each touch file is an empty file created using a Linux touch command and having a unique or distinct filename that is specified by the software code.

According to another example aspect of the invention, a method for dynamically configuring a software platform for a vehicle associated with an OEM is presented. In one exemplary implementation, the method comprises providing an ECU of the vehicle, establishing a cloud-based network configured to store a plurality of touch files, each touch file defining a set of vehicle configuration parameters, accessing, by the ECU, the cloud-based network to update and store the plurality of touch files, receiving and storing, by the ECU, a software code, wherein the software code identifies a particular touch file of the plurality of touch files, and executing, by the ECU, the software code using the set of vehicle configuration parameters specified by the particular touch file.

In some implementations, the plurality of touch files are configured to be updated at the cloud-based system without accessing the ECU. In some implementations, the plurality of touch files are configured to be updated at the cloud-based system without a firmware update of the ECU. In some implementations, the plurality of touch files are configured to be updated at the cloud-based system without a manual configuration change of the ECU by a technician.

In some implementations, the software code does not include a definition library. In some implementations, the definition library is a JSON library. In some implementations, the plurality of touch files are associated with each of a plurality of different ECUs of the vehicle. In some implementations, the plurality of touch files are configured to be updated by a programmer or developer of the software code. In some implementations, each touch file is an empty file created using a Linux touch command and having a unique or distinct filename that is specified by the software code.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are functional block diagrams depicting an example vehicle and an example dynamically configurable software platform for the vehicle according to the principles of the present application;

FIG. 2 is functional block diagrams depicting an example dynamic configuration operation of the dynamically configurable software platform according to the principles of the present application; and

FIG. 3 is a flow diagram of an example method of dynamically configuring embedded software of an electronic control unit (ECU) of a vehicle according to the principles of the present application.

### DESCRIPTION

As previously discussed, conventional vehicle embedded software, however, is static and is therefore difficult to update once deployed. This severely limits the ability of original equipment manufacturers (OEMs) and service providers to rapidly meet emerging customer needs or evolving market trends. The long development and testing cycles typically required for periodic firmware updates lead to delayed feature introductions and lost revenue opportunities. Instead of periodic firmware updates, manual configuration changes could be employed, but this is error prone and does not scale well. Some OEMs have also developed proprietary platforms offering more flexibility, but these are expensive to build and maintain and also suffer from interoperability issues. Some of the drawbacks or shortcomings \of these conventional solutions include the need for specialized technical expertise, long lead times, and high costs. The lack of standardization across models and manufacturers also makes consistent deployment of new features challenging. For firmware updates, the development and testing cycle is cumbersome and causes delays in upgrading software. Manual configuration changes (e.g., by a human technician) are error prone and do not scale well for efficient, large-scale modifications. Proprietary software platforms improve flexibility but often suffer from interoperability issues, thereby locking users into specific ecosystems, while also being expensive to build and maintain over the long term.

Accordingly, an innovative software platform solution that enables real-time changes to its behavior using “touch files” specifying a configuration (e.g., particular set of configuration parameters or an environment) for executed software code (a software application). The term “touch file” as used herein refers to a file created using a Linux® or similar type touch command and that is used by software code as a marker or a flag for parameter/environment configuration purposes. The touch files themselves could have unique or distinct filenames (e.g., identified in the software code, such as in if/then commands) but could otherwise be empty files. This software platform enables real-time behavior changes without specialized expertise or manual configuration (e.., large JavaScript Object Notation, or JSON libraries). These touch files can also be easily updated remotely (e.g., in the cloud), thereby making it simple to deploy new features and services across various models and manufacturers.

Additionally, using standard touch files promotes interoperability across models and manufacturers, enabling consistent feature deployment. This new software platform is designed to work with various in-vehicle systems including the data bus, infotainment system, and telematics unit. The platform integrates with these systems to collect data and modify functionality as needed. Furthermore, the platform can operate as a central hub to manage various applications and services. It also provides an interface for third-party solutions to plug into the broader in-vehicle network.

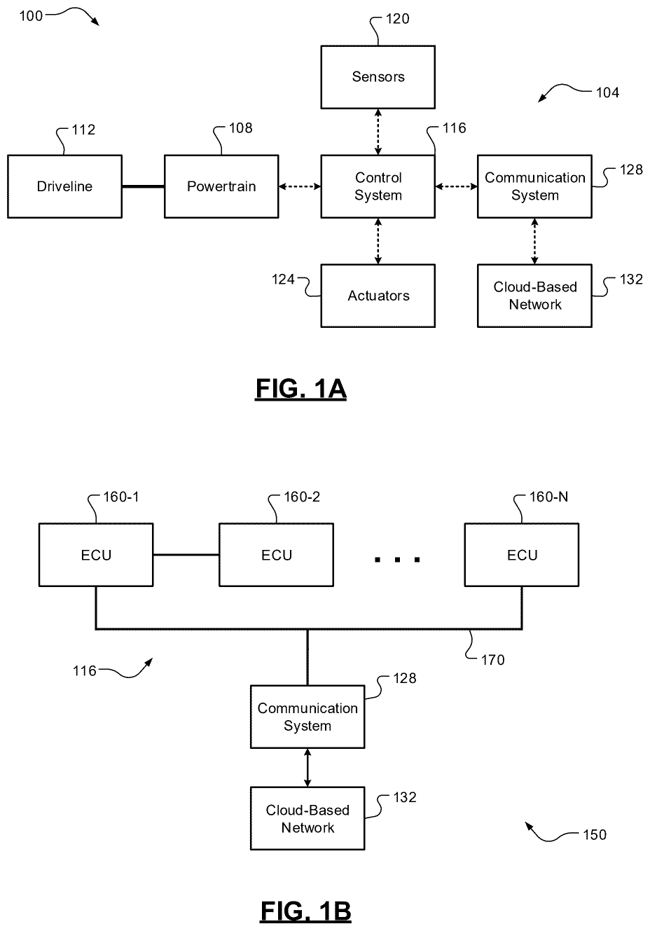

Referring now to FIGS. 1A-1B, functional block diagrams depicting an example vehicle 100 having a dynamically configurable software platform 104 and an example configuration 150 of the dynamically configurable software platform 104 are illustrated. The vehicle 100 could have any suitable configuration but, for illustrative/descriptive purposes, the vehicle 100 is shown to generally include a powertrain 108 configured to generate and transfer torque to a driveline 112 for propulsion. Non-limiting examples of the components of the powertrain 108 include an engine, an electric motor, a transmission, and combinations thereof. Non-limiting examples of the components of the driveline 112 include axles or half-shafts, differentials, and wheels. A control system 116 is configured to control operation of the vehicle 100, including receiving measurements from a plurality of sensors 120 and controlling a plurality of actuators or other vehicle systems 124. For example only, the control system 116 could receive a driver torque request via a driver interface or sensor (e.g., an accelerator pedal) and then control the powertrain 108 to generate an amount of drive torque to satisfy the driver torque request. The control system 116 is also configured to communicate with external computing systems via a communication system 128 (e.g., a transceiver) and a network (e.g., a cellular or satellite data network). One such remote system is a cloud-based network 132, which could be one or more OEM computing servers.

In one exemplary configuration 150, the control system 116 comprises a plurality of controllers or ECUs 160-1 . . . 160-N (N being an integer greater than one; collectively, “ECUs 160”) configured to communicate with each other via a CAN 170 comprising one or more CAN buses. For example, the CAN 170 could include a plurality of different CAN buses and each CAN bus could be configured to broadcast a certain set of ECU signals. Non-limiting examples of the ECUs 160 include a supervisory or primary ECU (e.g., a vehicle control unit, or VCU) and subsidiary or secondary ECUs (an engine control unit, or ECU, a motor control unit, or MCU, a transmission control unit, or TCU, etc.). In some cases, the ECU signals broadcast on the CAN 170 are accessed by authenticated external computing devices, such as, but not limited to, the cloud-based network 132, which, as described above, could include one or more OEM computing servers and, in some cases, one or more authenticated software/application developer computing devices. This access could occur in real-time or could occur periodically, such as in offloaded or downloaded batches of data, which is discussed in greater detail below.

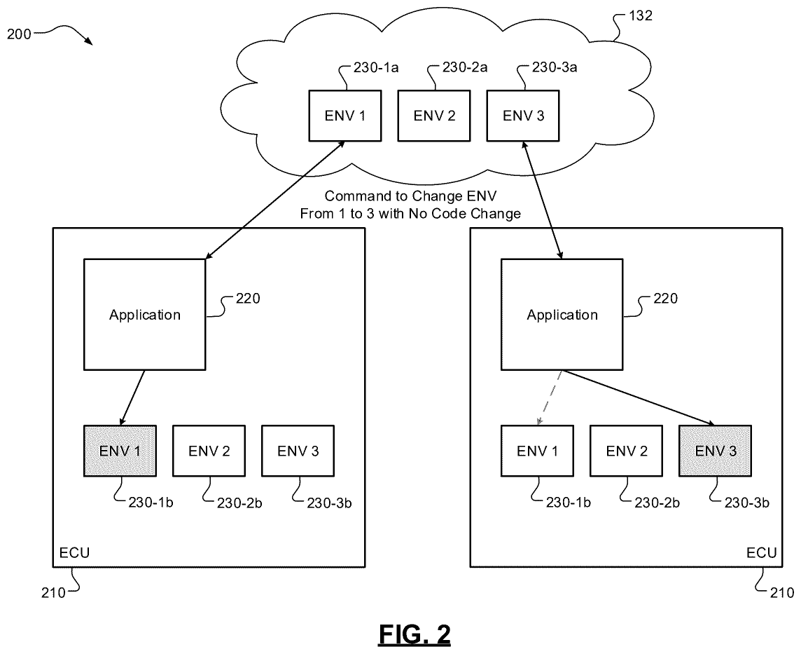

Referring now to FIG. 2 and with continued reference to FIGS. 1A-1B, functional block diagrams depicting an example dynamic configuration operation 200 of the dynamically configurable software platform according to the principles of the present application are illustrated. As shown, an ECU 210 (e.g., one of the plurality of ECUs 160 of the vehicle 100) receives and stores a software code 220 that, when executed by one or more processors (not shown) of the ECU 210, causes the ECU 210 to execute an application, which could be basic software (BSW) or an application software (ASW). The software code 220 is thus also referred to herein as application 220. The cloud-based network 132 stores a plurality of touch files 230-1a, 230-2a, and 230-3a (collectively, “touch files 230a”), each of which defines a set of configuration parameters for the vehicle 100, which are also referred to herein as environments or “ENV.”

The ECU 210 is configured to access the cloud-based network 132 to update and store the plurality of touch files 230a, which are shown separately stored at the ECU 210 as touch files 230-1b, 230-2b, and 230-3b (collectively, “touch files 230b”). Touch files 230a and 230b can also be collectively referred to as “touch files 230.” As previously mentioned, by using these touch files 230, the software code 220 does not need to include a definition library (e.g., a JSON library). This can substantially reduce the complexity of the software code 220 and thus can reduce the storage requirements and/or the processing load. This also allows for easy updates (e.g., not by an expert programmer) of the configuration parameters to extensively test the software code 220.

As previously mentioned, the touch files can be used as markers or flags. More specifically, for example, a software code could include something similar to “If touch file with the name “X” is present, do “Operation Y.” By creating these two files (e.g., touch files 230-1a and 230-1b), we can have the application 220 behave differently, such as connecting to a different environment or applying a different set of configuration parameters. In other words, the logic could already be built into the application 220, and it uses the presence of the touch files 230 to modify its behavior.

For example, in an initial state as shown in the left-side diagram, touch file 230-1b is identified by the software code 220 and its corresponding configuration parameters (ENV 1) are thereby loaded. In a subsequent state as shown in the right-side diagram, touch file 230-3b is identified by the software code 220 and its corresponding configuration parameters (ENV 3) are thereby loaded. This change could occur, for example, when the software code 220 is updated such that the different configuration parameters (corresponding to ENV 3 and touch file 230-3b) are now being specified instead of previously-specified configuration parameters (corresponding to ENV 1 and touch file 230-1b). In addition to the software code 220 being updatable, the plurality of touch files 230a are configured to be updated at the cloud-based system 132 without accessing the ECU 210 (e.g., without a firmware update of the ECU 210 or a manual configuration change of the ECU 210 by a technician).

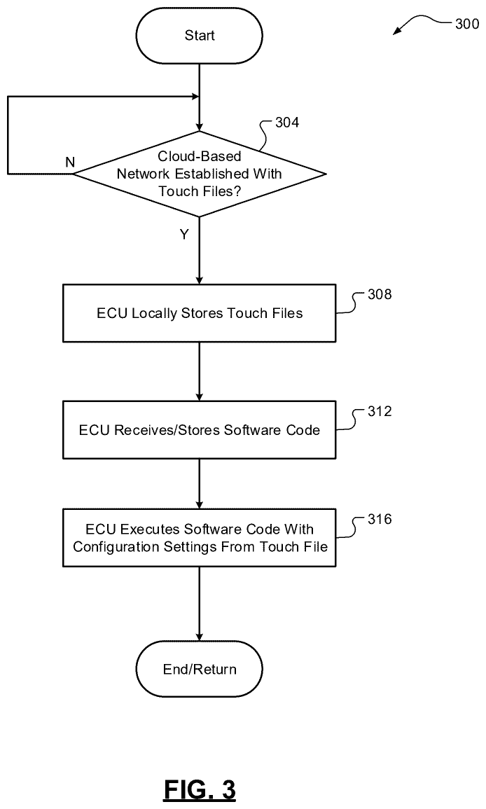

Referring now to FIG. 3 and with continued reference to the previous figures, a flow diagram depicting an example method 300 for dynamically configuring embedded software at an ECU of a vehicle according to the principles of the present application is illustrated. While the method 300 specifically references the previous figures (FIGS. 1A-1B and 2) and the previously discussed components (e.g., vehicle 100), it will be appreciated that the method 300 could be applicable to any suitable vehicle and CAN network implementations.

The method 300 begins at 304 where the cloud-based network 132 is established and stores a plurality of touch files 230a each defining a set of vehicle configuration parameters (also referred to herein as an environment or ENV). This step 304 could also include updating or revising of at least some of the touch files 230a over time (e.g., by a programmer or developer of a software code 220). At 308, an ECU 160 of the control system 116 of the vehicle 100 accesses the cloud-based network 132 to update and locally store the plurality of touch files 230b. At 312, the ECU 210 receives and stores the software code 220 (also referred to herein as an application 220) that identifies a particular touch file of the plurality of touch files 230b. At 316, the ECU 210 executes the software code 220 using the set of vehicle configuration parameters (e.g., ENV 1 or ENV 3) specified by the particular touch file (e.g., 230-1b or 230-3b). No firmware update of the ECU 210 or manual configuration change of the ECU 210 by a technician is necessary. The method 300 then ends or returns to 308.

It will be appreciated that the terms “controller” and “control system” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A dynamically configurable software platform for a vehicle associated with an original equipment manufacturer (OEM), the dynamically configurable software platform comprising:
an electronic control unit (ECU) of the vehicle; and
a cloud-based network configured to store a plurality of touch files, each touch file defining a set of vehicle configuration parameters;
wherein the ECU is configured to:
access the cloud-based network to update and store the plurality of touch files;
receive and store a software code, wherein the software code identifies a particular touch file of the plurality of touch files; and
execute the software code using the set of vehicle configuration parameters specified by the particular touch file.

2. The dynamically configurable software platform of claim 1, wherein the plurality of touch files are configured to be updated at the cloud-based system without accessing the ECU.

3. The dynamically configurable software platform of claim 2, wherein the plurality of touch files are configured to be updated at the cloud-based system without a firmware update of the ECU.

4. The dynamically configurable software platform of claim 2, wherein the plurality of touch files are configured to be updated at the cloud-based system without a manual configuration change of the ECU by a technician.

5. The dynamically configurable software platform of claim 1, wherein the software code does not include a definition library.

6. The dynamically configurable software platform of claim 5, wherein the definition library is a JavaScript Object Notation (JSON) library.

7. The dynamically configurable software platform of claim 1, wherein the plurality of touch files are associated with each of a plurality of different ECUs of the vehicle.

8. The dynamically configurable software platform of claim 1, wherein the plurality of touch files are configured to be updated by a programmer or developer of the software code.

9. The dynamically configurable software platform of claim 1, wherein each touch file is an empty file created using a Linux touch command and having a unique or distinct filename that is specified by the software code.

10. A method for dynamically configuring a software platform for a vehicle associated with an original equipment manufacturer (OEM), the method comprising:
providing an electronic control unit (ECU) of the vehicle;
establishing a cloud-based network configured to store a plurality of touch files, each touch file defining a set of vehicle configuration parameters;
accessing, by the ECU, the cloud-based network to update and store the plurality of touch files;
receiving and storing, by the ECU, a software code, wherein the software code identifies a particular touch file of the plurality of touch files; and
executing, by the ECU, the software code using the set of vehicle configuration parameters specified by the particular touch file.

11. The method of claim 10, wherein the plurality of touch files are configured to be updated at the cloud-based system without accessing the ECU.

12. The method of claim 11, wherein the plurality of touch files are configured to be updated at the cloud-based system without a firmware update of the ECU.

13. The method of claim 11, wherein the plurality of touch files are configured to be updated at the cloud-based system without a manual configuration change of the ECU by a technician.

14. The method of claim 10, wherein the software code does not include a definition library.

15. The method of claim 15, wherein the definition library is a JavaScript Object Notation (JSON) library.

16. The method of claim 10, wherein the plurality of touch files are associated with each of a plurality of different ECUs of the vehicle.

17. The method of claim 10, wherein the plurality of touch files are configured to be updated by a programmer or developer of the software code.

18. The method of claim 10, wherein each touch file is an empty file created using a Linux touch command and having a unique or distinct filename that is specified by the software code.
